(19) United States
(12) Patent Application Publication
(10) Pub. No.: US 2025/0269476 A1
(43) Pub. Date: Aug. 28, 2025

(54) WELDING WIRE FOR GAS SHIELDED ARC WELDING, AND STEEL WIRE ROD OF WELDING WIRE FOR GAS SHIELDED ARC WELDING AND PRODUCTION METHOD THEREFOR

(71) Applicants: Zhangjiagang Rongsheng Special Steel Co. Ltd., Suzhou, Jiangsu (CN); INSTITUTE OF RESEARCH OF IRON AND STEEL, JIANGSU PROVINCE/SHA-STEEL, CO. LTD (CN), Suzhou, Jiangsu (CN); JIANGSU SHAGANG GROUP CO., LTD., Suzhou, Jiangsu (CN)

(72) Inventors: Yu ZHANG, Suzhou, Jiangsu (CN); Yao TANG, Suzhou, Jiangsu (CN); Na WANG, Suzhou, Jiangsu (CN); Fu ZHAO, Suzhou, Jiangsu (CN)

(21) Appl. No.: 18/704,955

(22) PCT Filed: Feb. 25, 2022
(86) PCT No.: PCT/CN2022/078016

§ 371 Date: Apr. 26, 2024

(30) Foreign Application Priority Data
Jan. 6, 2022 (CN) 202210009859.3

(51) Int. Cl. B23K 35/30; B23K 35/02; C21D 6/00; C21D 8/06; C21D 9/52; C22C 38/00; C22C 38/02; C22C 38/44; C22C 38/58

(52) U.S. Cl. CPC B23K 35/3066; B23K 35/0227; C21D 6/004; C21D 6/005; C21D 6/008; C21D 8/065; C21D 9/525; C22C 38/002; C22C 38/02; C22C 38/44; C22C 38/58

(57) ABSTRACT

The present invention discloses a welding wire for gas shielded arc welding, and a steel wire rod of a welding wire for gas shielded arc welding and a production method therefor. Chemical components of the steel wire rod of a welding wire for gas shielded arc welding include, in mass percentage, 0.03%-0.08% of C, 0.5%-1.0% of Si, 1.4%-1.8% of Mn, 0.013%-0.1% of S, less than or equal to 0.0015% of P, less than or equal to 0.8% of Ni, less than or equal to 0.4% of Cr, less than or equal to 0.4% of Mo, and the balance of Fe and inevitable impurities; and a liquidus temperature T_{L}=1537-88 [C]-8 [Si]-5 [Mn]-30 [P]-25 [S], a solidus temperature T_{S}=1536-415 [C]-12 [Si]-6.8 [Mn]-125 [P]-184 [S],

### TECHNICAL FIELD

The present invention belongs to the technical field of welding materials, and relates to a welding wire for gas shielded arc welding, and a steel wire rod of a welding wire for gas shielded arc welding and a production method therefor.

### BACKGROUND

Steel is most widely used among metal materials, and is usually connected in a manner of welding. Gas shielded arc welding is a commonly used welding method.

In welding, the quality of welded joints determines the welding performance. The mechanical property and the forming property of the welded joints are important indexes for evaluating the quality of the welded joints, and the performance of welding wires is one important factor affecting the two properties.

When welding wires currently on the market are used for welding, especially during all-position welding on a pipeline and the like, the problem that weld metal at a position corresponding to the position of twelve o'clock, that is, at a position directly above a welded seam, flows downwards and falls often occurs, and consequently the forming property is poor and a weld bead is uneven.

### SUMMARY

In view of the defects in the prior art, the present invention aims to provide a welding wire for gas shielded arc welding, and a steel wire rod of a welding wire for gas shielded arc welding and a production method therefor, so as to solve the problems that during all-position welding, weld metal at a position corresponding to the position of twelve o'clock flows downwards and falls, and consequently the forming property is poor and a weld bead is uneven.

In order to realize the above-described objective of the present invention, an embodiment of the present invention provides a steel wire rod of a welding wire for gas shielded arc welding, chemical components of which include, in mass percentage, 0.03%-0.08% of C, 0.5%-1.0% of Si, 1.4%-1.8% of Mn, 0.013%-0.1% of S, less than or equal to 0.0015% of P, less than or equal to 0.8% of Ni, less than or equal to 0.4% of Cr, less than or equal to 0.4% of Mo, and the balance of Fe and inevitable impurities; and mass percentages of C, Si, Mn, P, and S satisfy: a liquidus temperature T_{L}=1537-88 [C]-8 [Si]-5 [Mn]-30 [P]-25 [S], a solidus temperature T_{S}=1536-415 [C]-12 [Si]-6.8 [Mn]-125 [P]-184 [S], and 25° C.≤T_{L}-T_{S}≤45° C.

C, as one of important elements in the steel wire rod of a welding wire, can reduce the average size of austenite grains, reduce proeutectoid ferrite, and increase acicular ferrite, thereby effectively improving the strength and hardness of weld metal, improving arc stability during welding, and improving a transient performance of a molten drop.

Si, as a main deoxidizing element and strengthening element in the steel wire rod of a welding wire, is mainly subjected to solution treatment in austenite and ferrite, thereby playing a solution treatment strengthening role, which can effectively improve the strength of a welded seam.

Mn, as a deoxidizing element in a welding process, forms an oxide in a deoxidizing process, which can improve the strength and toughness of the welded seam, and also can improve the content of the acicular ferrite in the weld metal, reduce the proeutectoid ferrite and ferrite side-plate, and refine the acicular ferrite at the same time.

S, with a content in a range of 0.013%-0.1%, can improve surface activity of the molten drop, and increase fluidity of the weld metal, thereby being conducive to forming the welded seam, and moreover avoiding a harmful effect on the toughness of the welded seam.

For P, as an impurity element in the steel wire rod of a welding wire, if the content thereof is too high, it will be easy to produce component segregation at a late stage of solidification of molten steel, being unfavorable to drawing of the steel wire rod, and also unfavorable to the low-temperature toughness of the welded seam.

Ni is an element for improving the strength and low-temperature impact toughness of the welded seam, and Ni can refine a structure to promote formation of the acicular ferrite, thereby playing an important strengthening role in the weld metal.

Cr can increase the content of the acicular ferrite in the welded seam, thereby improving the strength and low-temperature toughness of the welded seam.

Mo can lower a phase-transition temperature, inhibit generation of the proeutectoid ferrite, promote transformation of the acicular ferrite, and increase a proportion of the acicular ferrite, thereby being conducive to improving the strength and toughness.

In summary, the above elements and the weight percentage ranges thereof are reasonably set, which can ensure the strength and toughness of the weld metal and a smooth welding process. On the basis of reasonable design of the mass percentages of C, Si, Mn, P, Ni, Cr, and Mo, the content of S is controlled, which not only refines the molten drop in the welding process, so that a surface tension of the molten drop is reduced, thereby facilitating flow of a deposited metal, and improving the forming property of the welded seam, but also reduces cost of desulfurization in a steelmaking process. Further in combination with restrictions on the liquidus temperature and the solidus temperature of the welding wire, melting point and solidifying point intervals of the welding wire are controlled, so as to control a solidification speed of the weld metal, thereby making the weld metal have good fluidity and a weld pool solidify quickly, so that the problem that during all-position welding, the weld metal at the position corresponding to the position of twelve o'clock flows downwards and falls can be solved, and therefore during all-position welding, a surface of the welded seam is uniform and smooth, and the shape of a weld bead is attractive.

Preferably, mass percentages of C, Mn, Ni, Cr, and Mo satisfy: an austenite transformation start temperature Ar3=910-310 [C]-80 [Mn]-55 [Ni]-15 [Cr]-80 [Mo]; and a bainite transformation start temperature Bs-830-270 [C]-90 [Mn]-37 [Ni]-70 [Cr]-83 [Mo], and 30° C.≤Ar3-Bs≤80° C. By way of the reasonable design of various elemental constituents and the content of each element, the austenite transformation start temperature and the bainite transformation start temperature are regulated and controlled, so as to ensure that sufficient ferrite exists in the weld metal, thereby reducing a residual stress and deformation of a welded joint, improving the welding forming property, preparing a welding wire with a stable arc during welding, and realizing that during all-position welding, the surface of the welded seam is uniform and smooth, and the shape of the weld bead is attractive.

In order to realize the above-described objective of the present invention, an embodiment of the present invention provides a welding wire for gas shielded arc welding, which is prepared from the above-described steel wire rod of a welding wire for gas shielded arc welding as a base material. The above-described steel wire rod of a welding wire for gas shielded arc welding is used as the base material to prepare the welding wire for gas shielded arc welding with the diameter of 1.2 mm by way of drawing. With Ar+20% CO₂ used as shielding gas, a welding current of 220-230 A, and a welding voltage of 25 V, a fusion welding test is carried out. It is found that an excellent welding process performance is achieved, a tensile strength of the obtained weld metal is 770 MPa or above, an impact energy at −40° C. is 98 J or above, and the shape of the welded seam is attractive.

In order to realize the above-described objective of the present invention, an embodiment of the present invention provides a production method for preparing the steel wire rod of a welding wire for gas shielded arc welding, including the following processes carried out in sequence:
molten steel smelting;
refining;
steel billet casting: casting molten steel obtained from refining into steel billet;
temperature-controlled heating: carrying out temperature-controlled heating on the obtained steel billet in a heating furnace;
temperature-controlled rolling: rolling the steel billet obtained from the temperature-controlled heating process into the steel wire rod after descaling with high-pressure water, where a descaling water pressure is greater than or equal to 18 MPa, an intermediate mill uses a machining rolling groove, the steel wire rod is centrally cooled after finishing rolling, and wire discharging is performed after cooling; and
Stelmor slow cooling: carrying out slow cooling on the steel wire rod obtained from the temperature-controlled rolling process on a Stelmor slow cooling line, where heat preservation covers and fan air vents are all closed, and a cooling speed of the steel wire rod in a phase-transition temperature interval is less than or equal to 0.8° C./s.

By way of temperature-controlled rolling, and control over the Stelmor slow cooling, oxide scale on a surface of the steel billet can be effectively removed, and residual oxide scale can be prevented from being pressed into a deep structure of the steel wire rod in a process of rolling into the steel wire rod. Moreover, by way of the machining rolling groove, surface flatness of the steel wire rod can be ensured, and the situation that since a surface of the rolling groove is rough, a defect on a surface of the steel wire rod increases can also be avoided, so that surface quality and structure and strength properties of the steel wire rod are ensured, thereby facilitating drawing.

As a further improvement of an embodiment, on the Stelmor slow cooling line, a total length of all the heat preservation covers is greater than 80 m, an inlet roller way speed of the Stelmor slow cooling line is less than or equal to 0.18 m/s, and an outlet roller way speed thereof is less than or equal to 0.40 m/s, so as to realize that the cooling speed of the steel wire rod in the phase-transition temperature interval is less than or equal to 0.8° C./s, prolong retention time in the phase-transition temperature interval, realize reasonable control over the thickness and structure of the oxide scale on the surface of the steel wire rod to improve a mechanical peeling performance of the oxide scale, and improve uniformity of an internal structure of the steel wire rod, thereby being conducive to drawing the steel wire rod into a welding wire.

As a further improvement of an embodiment, in the temperature-controlled rolling process, a rolling start temperature is 970-1000° C., an inlet temperature of a finishing mill is less than or equal to 880° C., and a wire discharging temperature is 880-910° C. Therefore, effective control over the thickness and structure of the oxide scale on the surface of the steel wire rod can be realized, so that the thickness of the oxide scale on the surface of the steel wire rod obtained is 10 μm or above, and the steel wire rod is made to have an excellent oxide scale peeling performance.

As a further improvement of an embodiment, in the refining process, the molten steel obtained from the molten steel smelting process is refined in an ladle furnace; during refining, deoxidization and desulfurization are carried out by making white slag, refining time is greater than or equal to 35 min, and time for making the white slag is greater than or equal to 15 min; the content of other alloys is adjusted to meet requirements of a target range before feeding a ferrotitanium wire; and soft stirring time in a later stage of refining is greater than or equal to 15 min. By way of control over timing for feeding the ferrotitanium wire, a burning loss of titanium in an early stage of refining is avoided, thereby improving a yield of a titanium element, optimizing chemical constituents of a final steel wire rod and effectively controlling production cost, and ensuring the structure and strength of the prepared steel wire rod, and the welding performance of the welding wire. Further by way of control over time during refining, uniformity of components in the molten steel can be improved, so as to reduce macro and micro segregation of the steel billet, and improve the structure and strength of the ultimately obtained steel wire rod, thereby facilitating drawing into the welding wire.

As a further improvement of an embodiment, in the steel billet casting process, the molten steel obtained from the refining process is cast with full protection, a degree of superheat of the molten steel is 18-35° C., casting billet is maintained at a constant casting speed, and the casting speed is 2.5-2.7 m/min. By controlling parameters in the casting process, homogenization of the molten steel can be improved, and component segregation of the steel billet is reduced, so that the structure and strength of the ultimately obtained steel wire rod and the welding wire can be enhanced, thereby improving the forming property of the welding wire.

As a further improvement of an embodiment, in the temperature-controlled heating process, a temperature of a heating zone is 960-1020° C., and a temperature of a soaking zone is 1080-1120° C.

As a further improvement of an embodiment, in the molten steel smelting process, smelting raw materials including molten iron and steel scrap are smelted in a converter, a weight percentage of the molten iron in the smelting raw materials is greater than 90%, and a ferrosilicon alloy, a silicomanganese alloy, a low-carbon ferromanganese alloy, and lime are sequentially added into the molten steel when tapping is performed by 1/3. In this way, a weight percentage of the molten iron and timing for adding the various alloys and the lime are controlled, so as to ensure a high degree of purity of constituents of the molten steel, and improve the structure and strength of the steel wire rod and the ultimately prepared welding wire, thereby being conducive to drawing the steel wire rod into the welding wire, and improving the welding performance of the welding wire.

Compared with the prior art, the present invention has the beneficial effects that according to the welding wire for gas shielded arc welding, and the steel wire rod of a welding wire for gas shielded arc welding and the production method therefor of the present invention, on the basis of reasonable design of the components and the mass percentages thereof, not only is cost of desulfurization in the steelmaking process reduced, but also the weld metal has good fluidity, the weld pool solidifies quickly, and the welded seam has a good forming property, thereby solving the problem that during all-position welding, the weld metal at the position corresponding to the position of twelve o'clock flows downwards and falls, so that during all-position welding, the surface of the welded seam is uniform and smooth, and the shape of the weld bead is attractive. Further by improving the uniformity and degree of purity of the components of the molten steel, reducing the macro and micro segregation of billet, and improving the depth of the defect on the surface of the steel wire rod, the uniformity of the structure and strength of the steel wire rod, the mechanical peeling performance of iron oxide scale, plasticity and the like, a tensile strength of the steel wire rod finally obtained using the production method can reach 650 MPa or above, a drawing property is excellent, and the steel wire rod can be drawn into the welding wire for gas shielded arc welding with the diameter of 1.2 mm. When the fusion welding test is carried out in the case where Ar+20% CO₂ are used as shielding gas, the welding current is 220-230 A, and the welding voltage is 25 V, an excellent welding process performance is achieved, the tensile strength of the obtained weld metal is 770 MPa or above, the impact energy at −40° C. is 98 J or above, and the shape of the welded seam is attractive.

### BRIEF DESCRIPTION OF THE DRAWINGS

FIG. 1 is a picture of a welded seam in an example of the present invention; and

FIG. 2 is a picture of a welded seam in a comparative example of the present invention.

### DETAILED DESCRIPTION

An embodiment of the present invention provides a steel wire rod of a welding wire for gas shielded arc welding, a welding wire for gas shielded arc welding, and a production method for a steel wire rod of a welding wire for gas shielded arc welding.

In the steel wire rod of a welding wire for gas shielded arc welding of the present invention, chemical components of which include, in mass percentage, 0.03%-0.08% of C, 0.5%-1.0% of Si, 1.4%-1.8% of Mn, 0.013%-0.1% of S, less than or equal to 0.0015% of P, less than or equal to 0.8% of Ni, less than or equal to 0.4% of Cr, less than or equal to 0.4% of Mo, and the balance of Fe and inevitable impurities; and mass percentages of C, Si, Mn, P, and S satisfy: a liquidus temperature T_{L}=1537-88 [C]-8 [Si]-5 [Mn]-30 [P]-25 [S], a solidus temperature T_{S}=1536-415 [C]-12 [Si]-6.8 [Mn]-125 [P]-184 [S], and 25° C.≤T_{L}-T_{S}≤45° C.

In the above-described formulae for the liquidus temperature T_{L} and the solidus temperature T_{S}, square brackets “[ ]” denote a mass percentage of an element therein, for example, [C] denotes a mass percentage of C, and so on for other elements.

Preferably, mass percentages of C, Mn, Ni, Cr, and Mo satisfy: an austenite transformation start temperature Ar3-910-310 [C]-80 [Mn]-55 [Ni]-15 [Cr]-80 [Mo]; and a bainite transformation start temperature Bs-830-270 [C]-90 [Mn]-37 [Ni]-70 [Cr]-83 [Mo], and 30° C.≤Ar3-Bs≤80° C.

Similarly, in the above formulae for the austenite transformation start temperature Ar3 and the bainite transformation start temperature Bs, square brackets “[ ]” denote a mass percentage of an element therein, for example, [C] denotes a mass percentage of C, and so on for other elements.

The steel wire rod of a welding wire for gas shielded arc welding can be used as a base material for producing the welding wire for gas shielded arc welding.

In another aspect, an embodiment of the present invention further provides a welding wire for gas shielded arc welding, and the welding wire for gas shielded arc welding is prepared from the steel wire rod of a welding wire for gas shielded arc welding as a base material. For example, the steel wire rod of a welding wire for gas shielded arc welding is subjected to a drawing process so as to prepare the welding wire for gas shielded arc welding, and the diameter of the welding wire for gas shielded arc welding is 1.2 mm. When a fusion welding test is carried out in the cases where Ar+20% CO₂ are used as shielding gas, a welding current is 220-230 A, and a welding voltage is 25 V, an excellent welding process performance is achieved, a tensile strength of the obtained weld metal is 770 MPa or above, an impact energy at −40° C. is 98 J or above, and the shape of a welded seam is attractive.

An embodiment of the present invention further provides a production method for preparing the steel wire rod of a welding wire for gas shielded arc welding, as described before, the production method of the present invention is obtained according to lots of experimental study, and various processes in the production method are further described below.

### (1) Molten Steel Smelting

Smelting raw materials including molten iron and steel scrap are smelted in a converter, and a weight percentage of the molten iron in the smelting raw materials is greater than 90%, so as to ensure a degree of purity of components of the molten steel. A ferrosilicon alloy, a silicomanganese alloy, a low-carbon ferromanganese alloy, and lime are sequentially added into the molten steel when tapping is performed by 1/3, so as to adjust the content of constituents in the molten steel and make slag, and effectively improve the degree of purity of the molten steel, thereby improving the structure and strength of the steel wire rod.

The steel scrap is preferably high-quality steel scrap such as head and tail billet which is cut waste during smelting of low-carbon steel, and of course, the steel scrap is not limited to this. By using the high-quality steel scrap with a higher degree of purity and fewer impurities, difficulty of impurity removal in subsequent processes can be reduced, and the molten steel can have a higher degree of purity.

### (2) Refining

The molten steel obtained from the molten steel smelting process is refined in an ladle furnace. During refining, deoxidization and desulfurization are carried out by making white slag, refining time is greater than or equal to 35 min, time for making white slag is greater than or equal to 15 min, and the content of other alloys is adjusted to meet requirements of a target range before feeding a ferrotitanium wire. Soft stirring time in a later stage of refining is greater than or equal to 15 min. By way of control over timing for feeding the ferrotitanium wire, a burning loss of titanium in an early stage of refining is avoided, thereby improving a yield of a titanium element, optimizing chemical constituents of a final steel wire rod and effectively controlling production cost. By way of control over time of various treatment during refining, homogenization of the molten steel can be greatly improved so as to reduce macro and micro segregation of the obtained steel billet, thereby improving the structure and strength of the ultimately obtained steel wire rod.

### (3) Steel Billet Casting

The molten steel obtained from the refining process is cast with full protection, where a degree of superheat of the molten steel is 18-35° C., casting billet is maintained at a constant casting speed, and the casting speed is 2.5-2.7 m/min; and steel billet with a cross-section size of 140 mm×140 mm is obtained, and of course, the size of the steel billet is not limited to this. By controlling parameters such as the degree of superheat and the casting speed, homogenization of the molten steel can be greatly improved, and component segregation of the steel billet is reduced, so that the structure and strength of the ultimately obtained steel wire rod can be enhanced.

### (4) Temperature-Controlled Heating

Temperature-controlled heating is carried out on the obtained steel billet in a heating furnace, preferably, a temperature of a heating zone is 960-1020° C., and a temperature of a soaking zone is 1080-1120° C.

### (5) Temperature-Controlled Rolling

The steel billet obtained from the temperature-controlled heating process is rolled into the steel wire rod after descaling with high-pressure water, where chemical components of the steel wire rod include, in mass percentage, 0.03%-0.08% of C, 0.5%-1.0% of Si, 1.4%-1.8% of Mn, 0.013%-0.1% of S, less than or equal to 0.0015% of P, less than or equal to 0.8% of Ni, less than or equal to 0.4% of Cr, less than or equal to 0.4% of Mo, and the balance of Fe and inevitable impurities; and mass percentages of C, Si, Mn, P, and S satisfy: a liquidus temperature T_{L}=1537-88 [C]-8 [Si]-5 [Mn]-30 [P]-25 [S], a solidus temperature T_{S}=1536-415 [C]-12 [Si]-6.8 [Mn]-125 [P]-184 [S], and 25° C.≤T_{L}-T_{S}≤45° C. Therefore, when the steel wire rod is drawn into the welding wire and the welding wire is used for welding, the strength and toughness of weld metal and a smooth welding process can be ensured. Not only can a molten drop in the welding process be refined, so that a surface tension of the molten drop is reduced, thereby facilitating flow of a deposited metal, and improving the forming property of the welded seam, but also cost of desulfurization in a steelmaking process is reduced. Further in combination with restrictions on the liquidus temperature and the solidus temperature of the welding wire, melting point and solidifying point intervals of the welding wire are controlled, so as to control a solidification speed of the weld metal, thereby making the weld metal have good fluidity and a weld pool solidify quickly, so that the problem that during all-position welding, the weld metal at the position corresponding to the position of twelve o'clock flows downwards and falls can be solved, and therefore during all-position welding, a surface of the welded seam is uniform and smooth, and the shape of a weld bead is attractive.

Preferably, in the chemical components of the steel wire rod, mass percentages of C, Mn, Ni, Cr, and Mo satisfy: an austenite transformation start temperature Ar3=910-310 [C]-80 [Mn]-55 [Ni]-15 [Cr]-80 [Mo], and a bainite transformation start temperature Bs=830-270 [C]-90 [Mn]-37 [Ni]-70 [Cr]-83 [Mo], and 30° C.≤Ar3-Bs≤80° C. Therefore, it is ensured that sufficient ferrite exists in the weld metal, thereby reducing a residual stress and deformation of a welded joint, improving the welding forming property, preparing a welding wire with a stable arc during welding, and realizing that during all-position welding, the surface of the welded seam is uniform and smooth, and the shape of the weld bead is attractive.

A descaling water pressure is greater than or equal to 18 MPa, an intermediate mill uses a machining rolling groove, the steel wire rod is centrally cooled after finishing rolling, and wire discharging is performed after cooling. By way of control over the descaling water pressure, oxide scale on a surface of the steel billet can be effectively removed, and residual oxide scale can be prevented from being pressed into a deep structure of the steel wire rod in a process of rolling into the steel wire rod. The machining rolling groove is used, so that surface flatness of the steel wire rod can be ensured, and a defect on a surface of the steel wire rod caused by the fact that a surface of the rolling groove is rough can also be alleviated.

Preferably, when the steel billet is rolled after descaling with the high-pressure water, a rolling start temperature is 970-1000° C., an inlet temperature of a finishing mill is less than or equal to 880° C., and plasticity of the rolled steel wire rod can be improved by way of low-temperature rolling.

After the steel wire rod after finishing rolling is subjected to water cooling, wire discharging is performed, where a wire discharging temperature is 880-910° C., that is, water cooling is performed between a rolling mill and a wire discharging machine.

Specifically, in this embodiment, at least three water-cooling water tanks are sequentially provided between the rolling mill and the wire discharging machine. When the steel wire rod passes through the three water-cooling water tanks after leaving the rolling mill, only at most two water-cooling water tanks close to the wire discharging machine are opened, and the remaining water-cooling water tanks are closed. Of course, in other examples, the number of water-cooling water tanks used is not limited to this.

### (6) Stelmor Slow Cooling

Heat preservation and slow cooling is carried out on the steel wire rod obtained from the temperature-controlled rolling process on a Stelmor slow cooling line, where heat preservation covers and fan air vents are all closed, and a cooling speed of the steel wire rod in a phase-transition temperature interval is less than or equal to 0.8° C./s so as to prolong retention time of the steel wire rod in the phase-transition temperature interval, and realize reasonable control over the thickness and structure of oxide scale on the surface of the steel wire rod to improve a mechanical peeling performance of the oxide scale.

On the Stelmor slow cooling line, a total length of all the heat preservation covers is greater than 80 m, an inlet roller way speed of the Stelmor slow cooling line is less than or equal to 0.18 m/s, and an outlet roller way speed thereof is less than or equal to 0.40 m/s, so as to realize that a cooling speed of the steel wire rod in the phase-transition temperature interval is less than or equal to 0.8° C./s, and prolong the retention time in the phase-transition temperature interval, thereby reasonably controlling the thickness and structure of the oxide scale on the surface of the steel wire rod to facilitate peeling of the oxide scale, and improving uniformity of an internal structure of the steel wire rod, which is conducive to drawing the steel wire rod into a welding wire.

A specific embodiment of the present invention will be introduced below by way of five examples with specific serial numbers of 1-5 in combination with three comparative examples with serial numbers of 6-8.

### (1) Molten Steel Smelting

Smelting raw materials including molten iron and steel scrap are smelted in a 180 t converter, and a ferrosilicon alloy, a silicomanganese alloy, a low-carbon ferromanganese alloy, and lime are sequentially added into the molten steel when tapping is performed by 1/3. The mass percentage of S in each ladle of molten iron is 0.03%-0.18%. A total charge weight of the smelting raw materials, a weight percentage of the molten iron in the smelting raw materials, smelting time, a mass percentage of C during tapping, a tapping temperature and the like in the five examples and the three comparative examples are shown in Table 1.

TABLE 1

| | | | | | Mass | |
|---|---|---|---|---|---|---|
| | | | | | percentage | |
| | | Total charge | Ratio of the | Smelting | of C during | Tapping |
| Serial number | | weight | molten iron | time | tapping | temperature |
| Example | 1 | 200 t | 91% | 34 min | 0.035% | 1655° C. |
| | 2 | 202 t | 92% | 37 min | 0.035% | 1655° C. |
| | 3 | 198 t | 91% | 35 min | 0.037% | 1657° C. |
| | 4 | 200 t | 90% | 34 min | 0.035% | 1659° C. |
| | 5 | 197 t | 91% | 34 min | 0.035% | 1655° C. |
| Comparative | 6 | 200 t | 91% | 36 min | 0.032% | 1658° C. |
| example | 7 | 197 t | 91% | 34 min | 0.036% | 1655° C. |
| | 8 | 198 t | 93% | 33 min | 0.033% | 1654° C. |

Head and tail billet which is cut waste from low-carbon steel is used as the steel scrap in the five examples, and common steel scrap is selected in the three comparative examples.

### (2) Refining

The molten steel obtained from the molten steel smelting process is refined in an ladle furnace. During refining, deoxidization and desulfurization are carried out by making white slag, and the content of other alloys is adjusted to meet requirements of a target range before feeding a ferrotitanium wire. Soft stirring is performed in a later stage of refining, and soft stirring is performed with that a slag surface is slightly stirred and the molten steel is not exposed as a standard.

Refining time, white slag making time, soft stirring time and a tapping temperature in the five examples and the three comparative examples are respectively as shown in Table 2.

TABLE 2

| | | | Time for | Soft | |
|---|---|---|---|---|---|
| | | Refining | making white | stirring | Tapping |
| Serial number | | time | slag | time | temperature |
| Example | 1 | 38 min | 15 min | 15 min | 1595° C. |
| | 2 | 40 min | 16 min | 17 min | 1597° C. |
| | 3 | 38 min | 15 min | 15 min | 1596° C. |
| | 4 | 39 min | 16 min | 16 min | 1601° C. |
| | 5 | 38 min | 15 min | 15 min | 1595° C. |
| Comparative | 6 | 38 min | 15 min | 15 min | 1597° C. |
| example | 7 | 38 min | 15 min | 15 min | 1595° C. |
| | 8 | 38 min | 15 min | 15 min | 1594° C. |

### (3) Steel Billet Casting

The molten steel obtained from the refining process is cast with full protection, i.e., argon sealing for ladle shroud, a tundish covering agent, and integrated nozzle full-protection argon sealing are used for casting, and casting billet is maintained at a constant casting speed during casting, and an electromagnetic stirring current of a crystallizer is controlled to be 350 A with a frequency of 4 Hz, and a tail end electromagnetic stirring current is controlled to be 480 A with a frequency of 10 Hz, and the casting billet is cast into square billet with a cross-section size of 140 mm×140 mm. The degree of superheat of the molten steel and the casting speed in the five examples and the three comparative examples are shown in Table 3.

TABLE 3

| | | |
|---|---|---|
| | Degree of superheat | |
| Serial number | of the molten steel | Casting speed |

| | | | |
|---|---|---|---|
| Example | 1 | 30° C. | 2.5 m/min |
| | 2 | 32° C. | 2.5 m/min |
| | 3 | 31° C. | 2.6 m/min |
| | 4 | 33° C. | 2.5 m/min |
| | 5 | 30° C. | 2.4 m/min |
| Comparative | 6 | 30° C. | 2.5 m/min |
| example | 7 | 31° C. | 2.5 m/min |
| | 8 | 28° C. | 2.5 m/min |

### (4) Temperature-Controlled Heating

Temperature-controlled heating is carried out on the obtained steel billet in a heating furnace. A temperature of a heating zone, a temperature of a soaking zone, an air-fuel ratio of the soaking zone, and heat preservation time in the five examples and the three comparative examples are shown in Table 4.

TABLE 4

| | | | | Air-fuel | Heat |
|---|---|---|---|---|---|
| | | Temperature | Temperature | ratio | preser- |
| | | of a | of a | of the | vation |
| Serial number | | heating zone | soaking zone | soaking zone | time |
| Example | 1 | 960-1020° C. | 1080-1120° C. | Less than 0.7 | 56 min |
| | 2 | 960-1020° C. | 1080-1120° C. | Less than 0.7 | 56 min |
| | 3 | 960-1020° C. | 1080-1120° C. | Less than 0.7 | 60 min |
| | 4 | 960-1020° C. | 1080-1120° C. | Less than 0.7 | 56 min |
| | 5 | 960-1020° C. | 1080-1120° C. | Less than 0.7 | 60 min |
| Compar- | 6 | 960-1020° C. | 1080-1120° C. | Less than 0.7 | 56 min |
| ative | 7 | 960-1020° C. | 1080-1120° C. | Less than 0.7 | 60 min |
| example | 8 | 960-1020° C. | 1080-1120° C. | Less than 0.7 | 60 min |

### (5) Temperature-Controlled Rolling

The steel billet obtained from the temperature-controlled heating process is rolled into the steel wire rod after descaling with high-pressure water. A descaling water pressure, an amount of steel passing through a tungsten carbide roller ring used in the last two passes of finishing rolling, a rolling start temperature, an inlet temperature of a finishing mill, and a wire discharging temperature in the five examples and the three comparative examples are shown in Table 5. In addition, three water tanks numbered 5 #, 6 #and 7 #are provided in sequence from front to back between a finishing mill of the last pass and the wire discharging machine. Opening situations of the three water tanks in the five examples and the three comparative examples are also as shown in Table 5.

TABLE 5

| | | | | | Inlet | | |
|---|---|---|---|---|---|---|---|
| | | Descaling | Amount | | temperature | Wire | Opened |
| | | water | of steel | Rolling start | of a finishing | discharging | water |
| Serial number | | pressure | passing | temperature | mill | temperature | tank |
| Example | 1 | 20 MPa | 240 t | 970-1000° C. | Less than or | 900° C. | 6#, 7# |
| | | | | | equal to | | |
| | | | | | 880° C. | | |
| | 2 | 20 MPa | 240 t | 970-1000° C. | Less than or | 899° C. | 5#, 7# |
| | | | | | equal to | | |
| | | | | | 880° C. | | |
| | 3 | 20 MPa | 240 t | 970-1000° C. | Less than or | 900° C. | 6#, 7# |
| | | | | | equal to | | |
| | | | | | 880° C. | | |
| | 4 | 20 MPa | 240 t | 970-1000° C. | Less than or | 898° C. | 5#, 7# |
| | | | | | equal to | | |
| | | | | | 880° C. | | |
| | 5 | 20 MPa | 240 t | 970-1000° C. | Less than or | 903° C. | 6# |
| | | | | | equal to | | |
| | | | | | 880° C. | | |
| Comparative | 6 | 20 MPa | 240 t | 970-1000° C. | Less than or | 898° C. | 5#, 7# |
| example | | | | | equal to | | |
| | | | | | 880° C. | | |
| | 7 | 20 MPa | 240 t | 970-1000° C. | Less than or | 900° C. | 6#, 7# |
| | | | | | equal to | | |
| | | | | | 880° C. | | |
| | 8 | 20 MPa | 240 t | 970-1000° C. | Less than or | 900° C. | 6#, 7# |
| | | | | | equal to | | |
| | | | | | 880° C. | | |

### (6) Stelmor Slow Cooling

Heat preservation and slow cooling is carried out on the steel wire rod obtained from the temperature-controlled rolling process on a Stelmor slow cooling line, heat preservation covers and fan air vents are all closed, and a cooling speed of the steel wire rod in a phase-transition temperature interval is less than or equal to 0.8° C./s. A total length of all the heat preservation covers, an inlet roller way speed, an outlet roller way speed and the like of the Stelmor slow cooling line in the five examples and the three comparative examples are shown in Table 6.

A temperature of the steel wire rod in each heat preservation cover is measured by way of an infrared thermometer, so that the cooling speed of the steel wire rod in the phase-transition temperature interval is calculated accordingly. A cooling speed of a lap point and a cooling speed of a non-lap point are shown in Table 6, respectively. The lap point refers to areas adjacent to each other of the steel wire rod in adjacent circles, while the non-lap point refers to areas not in contact with each other of the steel wire rod in different circles.

TABLE 6

| | | Total length | | | | |
|---|---|---|---|---|---|---|
| | | of heat | | | Cooling | Cooling speed |
| | | preservation | Inlet roller | Outlet roller | speed of a | of a non-lap |
| Serial number | | covers | way speed | way speed | lap point | point |
| Example | 1 | 100 m | 0.15 m/s | 0.30 m/s | 0.5° C./s | 0.7° C./s |
| | 2 | 100 m | 0.15 m/s | 0.30 m/s | 0.5° C./s | 0.8° C./s |
| | 3 | 100 m | 0.15 m/s | 0.30 m/s | 0.6° C./s | 0.7° C./s |
| | 4 | 100 m | 0.15 m/s | 0.30 m/s | 0.5° C./s | 0.7° C./s |
| | 5 | 100 m | 0.15 m/s | 0.30 m/s | 0.4° C./s | 0.8° C./s |
| Comparative | 6 | 100 m | 0.15 m/s | 0.30 m/s | 0.5° C./s | 0.6° C./s |
| example | 7 | 100 m | 0.15 m/s | 0.30 m/s | 0.5° C./s | 0.7° C./s |
| | 8 | 100 m | 0.15 m/s | 0.30 m/s | 0.5° C./s | 0.7° C./s |

The final steel wire rod product is made according to the above-described production method in the five examples and the three comparative examples, and the obtained steel wire rod is tested.

The chemical components of the finished steel wire rod and the mass percentages (numerical unit, %) of the chemical components are shown in Table 7. The chemical components of the steel wire rod in the five examples include, in mass percentage, 0.03%-0.08% of C, 0.5%-1.0% of Si, 1.4%-1.8% of Mn, 0.013%-0.1% of S, less than or equal to 0.0015% of P, less than or equal to 0.8% of Ni, less than or equal to 0.4% of Cr, less than or equal to 0.4% of Mo, and the balance of Fe and inevitable impurities; and the mass percentages of the chemical components also satisfy: a liquidus temperature T_{L}=1537-88 [C]-8 [Si]-5 [Mn]-30 [P]-25 [S], a solidus temperature T_{S}=1536-415 [C]-12 [Si]-6.8 [Mn]-125 [P]-184 [S], 25° C.≤T_{L}-T_{S}≤45° C., and an austenite transformation start temperature Ar3=910-310 [C]-80 [Mn]-55 [Ni]-15 [Cr]-80 [Mo]; and a bainite transformation start temperature Bs=830-270 [C]-90 [Mn]-37 [Ni]-70 [Cr]-83 [Mo], and 30° C.≤Ar3-Bs≤80° C.

TABLE 7

| Serial number | | C | Si | Mn | S | P | Ni | Cr | Mo |
|---|---|---|---|---|---|---|---|---|---|
| Example | 1 | 0.064 | 0.54 | 1.70 | 0.013 | 0.0013 | 1.78 | 0.25 | 0.32 |
| | 2 | 0.059 | 0.54 | 1.66 | 0.016 | 0.0015 | 1.83 | 0.23 | 0.21 |
| | 3 | 0.068 | 0.60 | 1.59 | 0.031 | 0.0014 | 1.72 | 0.24 | 0.19 |
| | 4 | 0.064 | 0.57 | 1.65 | 0.033 | 0.0013 | 1.52 | 0.2 | 0.22 |
| | 5 | 0.062 | 0.54 | 1.67 | 0.041 | 0.0013 | 2.60 | 0.2 | 0.23 |
| Comparative | 6 | 0.064 | 0.54 | 1.7 | 0.013 | 0.0013 | 1.45 | 0.25 | 0.20 |
| example | 7 | 0.056 | 0.50 | 1.42 | 0.003 | 0.0013 | 0.43 | 0.21 | 0.19 |
| | 8 | 0.054 | 0.50 | 1.80 | 0.005 | 0.0013 | 1.03 | 0.25 | 0.20 |

The structure and mechanical property of the steel wire rod are measured as shown in Table 8.

TABLE 8

| | | Maximum | Minimum | | |
|---|---|---|---|---|---|
| | | value of | value of | | |
| | | a tensile | a tensile | Strength | |
| | | strength | strength | difference | Reduction |
| | | of the same | of the same | of the same | of a cross |
| Serial number | | circle/MPa | circle/MPa | circle/MPa | section/% |
| Example | 1 | 781 | 735 | 46 | 75 |
| | 2 | 746 | 704 | 42 | 72 |
| | 3 | 766 | 717 | 49 | 73 |
| | 4 | 743 | 697 | 46 | 71 |
| | 5 | 807 | 761 | 46 | 73 |
| Compar- | 6 | 747 | 694 | 53 | 72 |
| ative | 7 | 608 | 562 | 46 | 74 |
| example | 8 | 697 | 650 | 47 | 72 |

### (7) Drawing

The steel wire rod obtained from the Stelmor slow cooling process is drawn into the welding wire with the diameter of 1.2 mm. The welding wire is applied in gas shielded arc welding, and when (Ar+20% CO₂) are used as shielding gas for a fusion welding test, a welding current is 220-230 A, and a welding voltage is 25 V, the measured tensile strength of the weld metal and the impact energy at −40° C. are shown in Table 9.

TABLE 9

| Serial number | | Tensile strength | Impact energy at −40° C. |
|---|---|---|---|
| Example | 1 | 808 MPa | 98 J |
| | 2 | 775 MPa | 103 J |
| | 3 | 791 MPa | 107 J |
| | 4 | 770 MPa | 118 J |
| | 5 | 834 MPa | 122 J |
| Comparative | 6 | 771 MPa | 81 J |
| example | 7 | 635 MPa | 71 J |
| | 8 | 724 MPa | 76 J |

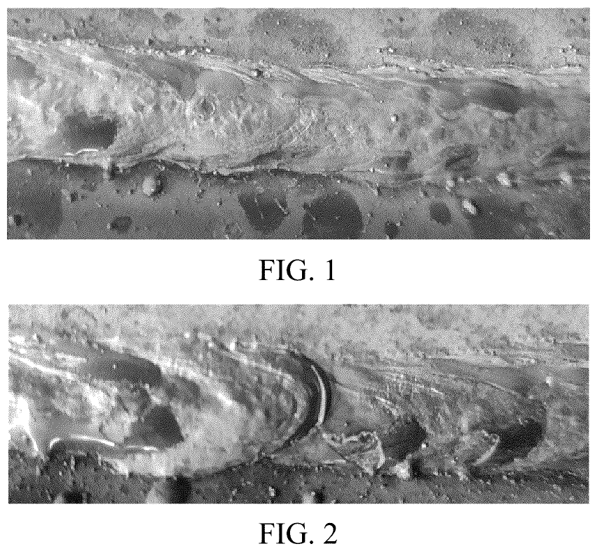

After implementation and verification, and in combination with FIG. 1, in which a picture of welded seams in some of Examples 1-5 are shown, it is found that: when the finished steel wire rod produced in Examples 1-5 by using the chemical constituents and production method described in this embodiment is drawn into the welding wire, an excellent welding process performance is achieved, and when the welding wire is used for full-position welding, the surface of the welded seam is uniform and smooth, and the shape of the weld bead is attractive. FIG. 2 shows a picture of welded seams in some examples of Comparative Examples 6-8, and it is found that: the content of some elements and key production process parameters in Comparative Examples 6-8 are not within the scope of this embodiment, when the steel wire rod is drawn into the welding wire, the welding process performance is poor, and when the welding wire is used for all-position welding, the surface of the welded seam is rough, and has an obvious dripping trace.

The above-described example only describes a specific embodiment of the present invention, but cannot therefore be understood as a limitation to the patent scope of the present invention. Any changes made to the present invention by those skilled in the art under the motivation of the concept of the present invention are all within the scope of protection of the present invention.

What is claimed is:

1. A steel wire rod of a welding wire for gas shielded arc welding, chemical components of the steel wire rod comprising, in mass percentage, 0.03%-0.08% of C, 0.5%-1.0% of Si, 1.4%-1.8% of Mn, 0.013%-0.1% of S, less than or equal to 0.0015% of P, less than or equal to 0.8% of Ni, less than or equal to 0.4% of Cr, less than or equal to 0.4% of Mo, and the balance of Fe and inevitable impurities; and mass percentages of C, Si, Mn, P, and S satisfy: a liquidus temperature T_{L}=1537-88 [C]-8 [Si]-5 [Mn]-30 [P]-25 [S], a solidus temperature T_{S}=1536-415 [C]-12 [Si]-6.8 [Mn]-125 [P]-184 [S], and 25° C.≤T_{L}-T_{S}≤45° C.

2. The steel wire rod of a welding wire for gas shielded arc welding according to claim 1, wherein mass percentages of C, Mn, Ni, Cr, and Mo satisfy: an austenite transformation start temperature Ar3=910-310 [C]-80 [Mn]-55 [Ni]-15 [Cr]-80 [Mo]; and a bainite transformation start temperature Bs=830-270 [C]-90 [Mn]-37 [Ni]-70 [Cr]-83 [Mo], and 30° C.≤Ar3-Bs≤80° C.

3. A welding wire for gas shielded arc welding, wherein the welding wire for gas shielded arc welding is prepared from the steel wire rod of a welding wire for gas shielded arc welding according to claim 1 as a base material.

4. A production method for the steel wire rod of a welding wire for gas shielded arc welding according to claim 1, comprising the following processes performed in sequence:
molten steel smelting;
refining;
steel billet casting: casting molten steel obtained from refining into steel billet;
temperature-controlled heating: carrying out temperature-controlled heating on the obtained steel billet in a heating furnace;
temperature-controlled rolling: rolling the steel billet obtained from the temperature-controlled heating process into the steel wire rod after descaling with high-pressure water, wherein a descaling water pressure is greater than or equal to 18 MPa, an intermediate mill uses a machining rolling groove, the steel wire rod is centrally cooled after finishing rolling, and wire discharging is performed after cooling; and
Stelmor slow cooling: carrying out slow cooling on the steel wire rod obtained from the temperature-controlled rolling process on a Stelmor slow cooling line, wherein heat preservation covers and fan air vents are all closed, and a cooling speed of the steel wire rod in a phase-transition temperature interval is less than or equal to 0.8° C./s.

5. The production method for the steel wire rod of a welding wire for gas shielded arc welding according to claim 4, wherein on the Stelmor slow cooling line, a total length of all the heat preservation covers is greater than 80 m, an inlet roller way speed of the Stelmor slow cooling line is less than or equal to 0.18 m/s, and an outlet roller way speed thereof is less than or equal to 0.40 m/s.

6. The production method for the steel wire rod of a welding wire for gas shielded arc welding according to claim 4, wherein in the temperature-controlled rolling process, a rolling start temperature is 970-1000° C., an inlet temperature of a finishing mill is less than or equal to 880° C., and a wire discharging temperature is 880-910° C.

7. The production method for the steel wire rod of a welding wire for gas shielded arc welding according to claim 4, wherein in the refining process, the molten steel obtained from the molten steel smelting process is refined in an ladle furnace; during refining, deoxidization and desulfurization are carried out by making white slag, refining time is greater than or equal to 35 min, and time for making the white slag is greater than or equal to 15 min; the content of other alloys is adjusted to meet requirements of a target range before feeding a ferrotitanium wire; and
soft stirring time in a later stage of refining is greater than or equal to 15 min.

8. The production method for the steel wire rod of a welding wire for gas shielded arc welding according to claim 4, wherein in the steel billet casting process, the molten steel obtained from the refining process is cast with full protection, a degree of superheat of the molten steel is 18-35° C., casting billet is maintained at a constant casting speed, and the casting speed is 2.5-2.7 m/min.

9. The production method for the steel wire rod of a welding wire for gas shielded arc welding according to claim 4, wherein in the temperature-controlled heating process, a temperature of a heating zone is 960-1020° C., and a temperature of a soaking zone is 1080-1120° C.

10. The production method for the steel wire rod of a welding wire for gas shielded arc welding according to claim 4, wherein in the molten steel smelting process, smelting raw materials comprising molten iron and steel scrap are smelted in a converter, a weight percentage of the molten iron in the smelting raw materials is greater than 90%, and a ferrosilicon alloy, a silicomanganese alloy, a low-carbon ferromanganese alloy, and lime are sequentially added into the molten steel when tapping is performed by 1/3.
